(19) United States
(12) Patent Application Publication
(10) Pub. No.: US 2015/0002305 A1
(43) Pub. Date: Jan. 1, 2015

(54) Methods and Devices Relating to Solid State Lighting

(71) Applicant: Regulus Solutions, Ottawa (CA)

(72) Inventor: Mark Wells, Ottawa (CA)

(21) Appl. No.: 14/312,809

(22) Filed: Jun. 24, 2014

Related U.S. Application Data
(60) Provisional application No. 61/840,657, filed on Jun. 28, 2013.

(51) Int. Cl. H05B 37/02; G08B 5/36; F21V 21/30

(52) U.S. Cl. CPC H05B 37/0272; F21V 21/30; G08B 5/36
USPC 340/815.4; 315/161; 362/427

(57) ABSTRACT

It would be beneficial for engineers when renewing municipal infrastructure to have the option of centralizing multiple services into one physical element of infrastructure. It would also be beneficial where one specific element of infrastructure may be replaced to address replacement or operating costs, e.g. when replacing high pressure sodium, xenon, metal-halide, or mercury lighting with solid state lighting, that the new infrastructure supports migration to an overall reduction in physical infrastructure as other services/infrastructure elements are renewed. It would be further beneficial for the deployed physical element of infrastructure minimize physical footprint, offer low cost design solutions, improve reliability, support evolving requirements, offer new services and revenue-generating opportunities, enhance the payback and return on investment, as well the evolving needs of emergency services, security organizations, etc.

### CROSS-REFERENCE TO RELATED APPLICATIONS

This patent application claims the benefit of priority from U.S. Provisional Patent Application 61/840,657 filed Jun. 28, 2013 entitled “Methods and Devices Relating to Solid State Lighting” the entire contents of which are incorporated herein by reference.

### FIELD OF THE INVENTION

This invention relates to municipal infrastructure and more particularly to provisioning of distributed, intelligent control and communications within municipal infrastructure elements such as lighting and traffic standards.

### BACKGROUND OF THE INVENTION

Infrastructure relates to the basic physical and organizational structures needed for the operation of a society or enterprise and can be generally defined as the set of interconnected structural elements that provide framework supporting an entire structure of development. In considering municipal environments the term typically refers to those technical structures that support a society, such as roads, bridges, water supply, sewers, electrical grids, telecommunications, etc. It would be evident that most of these technical structures are also present within the wider infrastructure of a city, town, municipality, region, country etc in order to support the interconnection of discrete urban areas into the city, town, municipality, region, and country, even continent.

Infrastructure systems include both the fixed assets, such as traffic lights, light stands, highway signage, sensors, etc., and the control systems and software required to operate, manage and monitor the systems, as well as any accessory buildings, plants, or vehicles that are an essential part of the system.

It is no secret that in a large number of countries the infrastructure is aging and failing, and that funding has generally been insufficient to repair and replace it. Accordingly municipalities, governments and engineers of the 21st century face the formidable challenge of modernizing the fundamental structures that support our daily lives and civilization whilst providing value for money both initially and during planned operational life, reduced maintenance, and support for evolving technological requirements. These issues are particularly acute in urban areas, where growing populations stress society's support systems, and natural disasters, accidents, and terrorist attacks threaten infrastructure safety and security. Urban infrastructure issues are not just a U.S., North American or Western World issue as special challenges are posed by the problems of megacities, those with populations exceeding 10 million, which are found mostly in Asia. Even outside of North America, Europe, the Middle East, and counties such as Brazil, Russia, Korea, Singapore, and Japan basic infrastructure needs in many regions of the world are still problematic, and engineers will be challenged to economically provide such services more broadly.

Furthermore, the solutions to these problems should be designed for sustainability, giving proper attention to environmental and energy-use considerations as although our cities take up just a small percentage of the Earth's surface, they disproportionately exhaust resources and generate pollution, along with concern for the aesthetic elements that contribute to the quality of life. Now, maintaining infrastructure is not a new problem as for thousands of years, engineers have had to design systems for providing clean water and disposing of sewage and building and maintaining roads. In recent centuries, systems for transmitting information and providing energy have expanded and complicated the infrastructure network, beginning with telegraph and telephone lines and now encompassing all sorts of telecommunications systems. Cable TV, cell phones, and Internet access all depend on elaborate infrastructure installations whilst the development of wind and solar energy resources will add more.

As if this was not enough much of the existing infrastructure outside of North America is buried, posing several problems for maintaining and upgrading it. In North America the trend in urban renewal projects is to similarly remove the historical pole mounted infrastructure (except for lighting) and replace it with underground infrastructures opening up sidewalks, improving aesthetics, etc. In many instances records for the locations of all the underground pipes and cables are unavailable, incomplete, or incorrect. Further, such infrastructure today consists of multiple ducts, channels, pipes, etc. through which multiple different systems all wind and weave their way with multiple operators (e.g. hydro, telecom, city, etc.) and generally different infrastructural renewal schedules defined by the operators. Only in instances such as water and sewage where wholesale opening up of the ground to access the piping is involved is coordination evident as many services such as telecom, electricity, traffic management, etc. have been added over time subsequent to the initial urbanization and provisioning of “mains” water/sewage.

Accordingly, it would be beneficial for engineers when renewing urban infrastructure to have the option of centralizing multiple services into one physical element of infrastructure. It would also be beneficial where one specific element of infrastructure may be replaced to address replacement or operating costs, e.g. replacing high pressure sodium, xenon, metal-halide, or mercury, etc. lighting with solid state and/or induction lighting, which the new infrastructure supports migration to an overall reduction in physical infrastructure as other services/infrastructure elements are renewed.

It would be further beneficial for the deployed physical element of infrastructure to minimize physical footprint, offer low cost design solutions, support evolving requirements, improve reliability, offer new services and revenue generating opportunities to enhance the payback and return on investment, as well the evolving needs of emergency services, security organizations, etc.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate technical and physical limitations within the prior art with respect to urban infrastructure and more particularly to provisioning of distributed, intelligent control and communications within urban infrastructure elements such as light and traffic standards.

In accordance with an embodiment of the invention there is provided a device comprising:

a microprocessor;

at least one wireless transceiver operating according to a predetermined standard;

at least one luminaire power supply;

at least one power feed input;

an optional metering-switching circuit coupled to the microprocessor, the luminaire power supply, and power feed input for determining a metered value; and

an optional at least one transceiver operating according to a predetermined standard for transmitting the metered value to a remote server.

In accordance with an embodiment of the invention there is provided a method comprising:

deploying a plurality of infrastructure interface modules (IIM), each IIM associated with a luminaire standard and comprising:

a microprocessor;

at least one luminaire power supply;

at least one wireless transceiver operating according to a predetermined standard;

an optional global positioning receiver for determining a geographical location of the device, wherein the geographical location is employed by the microprocessor to establish independent of other input the schedule for turning the luminaire power supply at least one of on and off; and

am optional sensor interface coupled to at least one sensor of a plurality of sensors, each sensor providing a sensor output in dependence upon a predetermined factor; and

determining in dependence upon a decision made by the microprocessor in dependence upon the at least one sensor output whether to at least one of generate and send an alarm signal from the IIM and override the luminaire power schedule and turn on the luminaire power supply.

In accordance with an embodiment of the invention there is provided a method comprising deploying a plurality of infrastructure interface modules (IIM), each IIM associated with a luminaire standard deploying a plurality of luminaires and comprising:

a microprocessor;

at least one luminaire power supply;

at least one wireless device operating according to a predetermined standard, the wireless device being at least one of a receiver, transmitter, and a transceiver; and

at least one power feed.

In accordance with an embodiment of the invention there is provided a device comprising:

an outer shell;

a first mounting for attaching a first end of the outer shell to a support, the support for attaching the device to a physical structure; and

a second mounting for attaching a second end of the outer shell to the support; wherein the first mounting and second mounting allow for the outer shell to be adjusted in both pitch and yaw relative to the support.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a municipal lighting architecture according to the prior art;

FIG. 2 depicts an exemplary distributed architecture for multiple services within a municipal environment according to the prior art;

FIG. 3 depicts East Aloha Street in Seattle before and after LED streetlights are installed;

FIGS. 4A and 4B depict exemplary architectures for multiple services within a municipal environment according to an embodiment of the invention;

FIG. 5 depicts an exemplary architecture for multiple services within a municipal environment according to an embodiment of the invention;

FIG. 6 depicts an exemplary architecture for multiple services within a municipal environment according to an embodiment of the invention;

FIG. 7 depicts an exemplary architecture for an Infrastructure Interface Module according to an embodiment of the invention for deployment;

FIG. 8 depicts a municipal environment with infrastructure architecture according to an embodiment of the invention incorporating Infrastructure Interface Modules according to an embodiment of the invention for deployment; and

FIGS. 9 and 10 depict an LED light assembly according to an embodiment of the invention.

### DETAILED DESCRIPTION

The present invention is directed to municipal infrastructure and more particularly to provisioning of distributed, intelligent control and communications within municipal infrastructure elements such as light and traffic standards.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function, topology, and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, in-vehicle infotainment systems, and an electronic reader. A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “standard” as used herein and throughout this disclosure, refers to a physical structure for supporting elements of the physical infrastructure. This includes, but is not limited to, wooden poles, concrete poles, metal poles, bollards, frames, as well as exterior surfaces of buildings, cabinets, enclosures, etc to which one or more elements of the physical infrastructure may be supported.

An “operator” as used herein and throughout this disclosure, refers to an organization employing one or more elements of the physical infrastructure. Such organizations include, but are not limited to, city departments, municipalities, governments, emergency responders, law enforcement agencies, military, utilities, and private enterprises.

A “location” as used herein and throughout this disclosure, refers to a geographical point at which a physical structure, e.g. stand, for supporting elements of the physical infrastructure is provided.

“Wireless” as used herein and throughout this disclosure refers to a communication system providing data transmission between two devices by means of electromagnetic energy within the microwave and/or radio-frequency (RF) ranges of the electromagnetic spectrum.

A “communications standard” as used herein and throughout this disclosure, refers to a standard relating to at least one of wireless, wired, and optical communications between two or more devices. Such “wireless communication standards” include, but are not limited to, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. “Wired communication standards” include, but are not limited to, IEEE 1394, VITA 49 Radio Transport (VRT), HDMI, InfiniBand, HDBase-T, IEEE 802.3 1000BASE (e.g. -T, -TX, -CX, -KX), Universal Serial Bus (USB), ITU-T G.707, ITU-T G.783, ITU-T G.784, and ITU-T G.803. Optical communications standards include, but are not limited to, IEEE 802.3 1000BASE (e.g. -SX, -LX, -LX10, EX, ZX, BX10), SDH OC, ITU-T G.983, ITU-T G. 984, ITU-T G.985, ITU-T G.986, ITU-T G.987, SONET (ANSI T1.105), ITU-T G.707, ITU-T G.783, ITU-T G.784, and ITU-T G.803.

A “network” as used herein, and throughout this disclosure, refers to a collection of terminal nodes, interconnecting links and any intermediate nodes which are connected so as to enable telecommunications, signalling, and/or communications between the terminals. Such links, terminal nodes, and any intermediate nodes may be deployed in one or more topologies and/or combinations of topologies including, point-to-point, multipoint, point-to-multipoint, linear bus, ring, mesh, and star. Such networks may exploit one or more communication protocols/standards as well as one or more transmission media including wired networks, wireless networks, and optical/infrared networks.

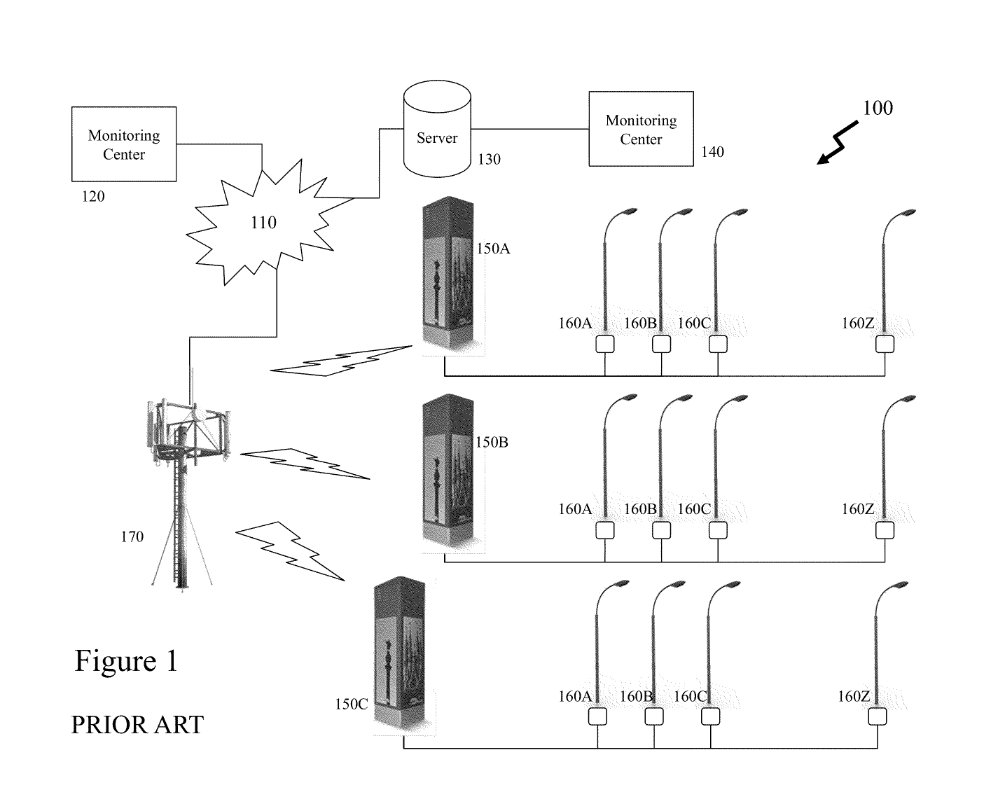

Referring to FIG. 1 there is depicted a schematic 100 of a prior art lighting infrastructure as might be installed today or within the recent past. As depicted first to third Street Cabinets 150A to 150C are in wireless communication with Cell Tower 170 which is then connected to first Monitoring Center 120 via Network 110 and second Monitoring Center 140 via Network 110 and Server 130. Accordingly, commands relating to turning on/off the first to N^{th} Street Lights 160A through 160Z connected to each of the first to third Street Cabinets 150A to 150C respectively may be communicated from one or both of the first and second Monitoring Centers 120 and 140 respectively. As such schematic 100 depicts the scenario where prior art timing devices installed within each of the first to N^{th} Street Lights 160A through 160Z have been replaced with switching circuits within the first to third Street Cabinets 150A to 150C respectively. It would be evident therefore that such systems allow for a wider range of program configurations to be executed in respect of the street lighting either automatically as their settings are stored within first or second Monitoring Centers 120 and 140 or Server 130 and communicated via Network 110 and Cell Tower 170 or are stored within local programmable logic controllers (PLCs) within the first to third Street Cabinets 150A to 150C respectively. One-off modifications may also be made, such as maintaining all street lights within an area on after their normal programming point of turning half of them off has passed as there is a festival in the area that night.

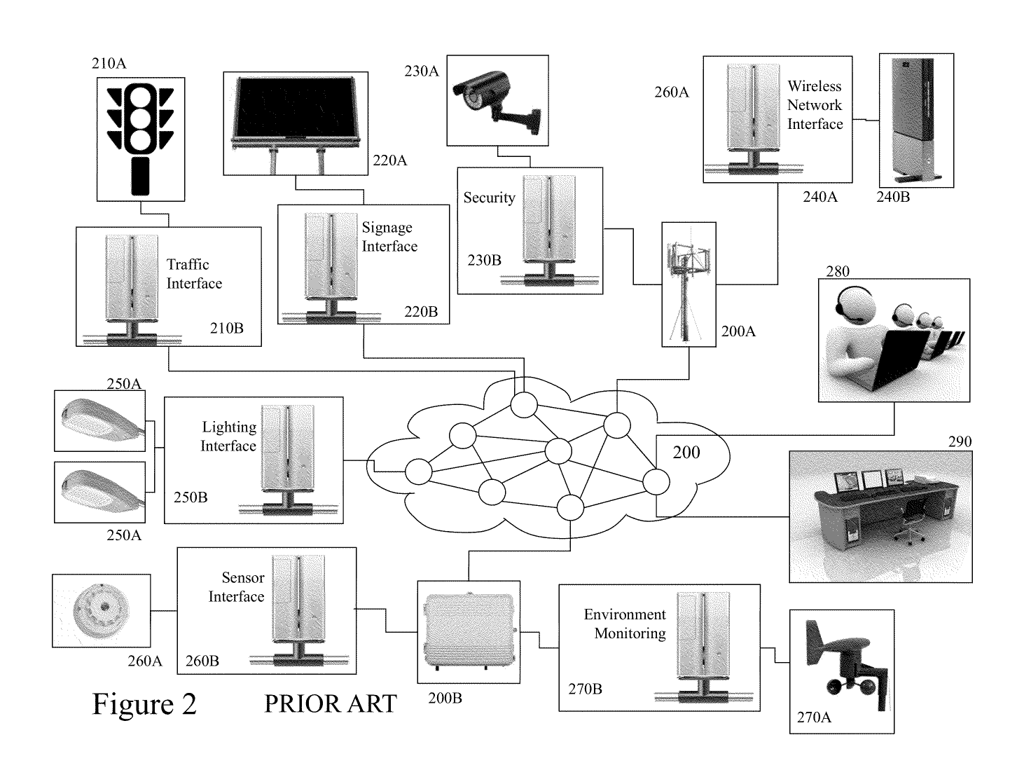

However, it would be evident that as depicted in FIG. 2 that a Lighting Interface 250B, for example first Street Cabinet 150A, connected to Light 250A, e.g. first Street Light 160A is just one of multiple services required and/or offered within an municipal environment. Also depicted within FIG. 2 are other such services including, but not limited to, traffic control indicated by Traffic Lights 210A and Traffic Interface 210B which is normally a pedestal mounted cabinet; signage as indicated by Sign 220A and Signage Interface 220B; security monitoring as indicate by CCTV Camera 230A and Security Interface 230B which may be connected to Network 200 with wireless and/or wired interfaces; and Wi-Fi as exemplified by Wi-Fi cell 240A and Wireless Network Interface 240B which may for example be a router. Other services may include sensors such as depicted by Sensor 260A with associated Sensor Interface 260B and environmental measurements such as depicted by Environmental Sensor 270A and Environment Monitoring 270B. Accordingly Traffic Interface 210B, Signage Interface 220B, Security Interface 230B, Wireless Network Interface 240B, Sensor Interface 260B, and Environment Monitoring 270B communicate via Network 200 to first and second Control Centers 280 and 290 respectively.

Typically multiple control centers would be controlling different aspects of the infrastructure within a given geographic area or at a specific geographic location. For example, traffic control would be typically centralized to a municipality control center or centers but lighting might be under management of a different department with different control center(s) and security under management of one or more control centers relating for example to police, paramedics, and fire. Further this may be managed at a regional level rather than municipal. Hence, in addition to multiple control centers these different elements of infrastructure even where deployed within a matter of a few meters or feet of one another exploit multiple different physical infrastructure elements, e.g. traffic lights on their own stand with separate control interface, e.g. Traffic Interface 210B, in a pedestal cabinet, street lighting on its own stand with separate control interface, e.g. Lighting Interface 250B, in street cabinet, wireless base station with separate electronics assembly, e.g. Wireless Network Interface 240B, in cabinet. Similarly, Sensor Interface 260B, Environmental Interface 270B, Security Interface 230B, and Signage Interface 220B may all be physically close to these other elements and each requires dedicated physical locations, electrical power supplied to it, and network access such as through wired, optical, and/or wireless interfaces to Network 200 or intermediate demarcation interfaces such as first and second Network Access Points 200A and 200B respectively. Network Access Point 200A being a cellular base station which typically provides demarcation between wireless client side interfaces and wired or optical interfaces to the Network 200. Network Access Point 200B being a Network Interface Controller (NIC) which may for example connect via 10 GBase-T to Network 200 and via Ethernet connections to Sensor Interface 260B and Environmental Interface 270B.

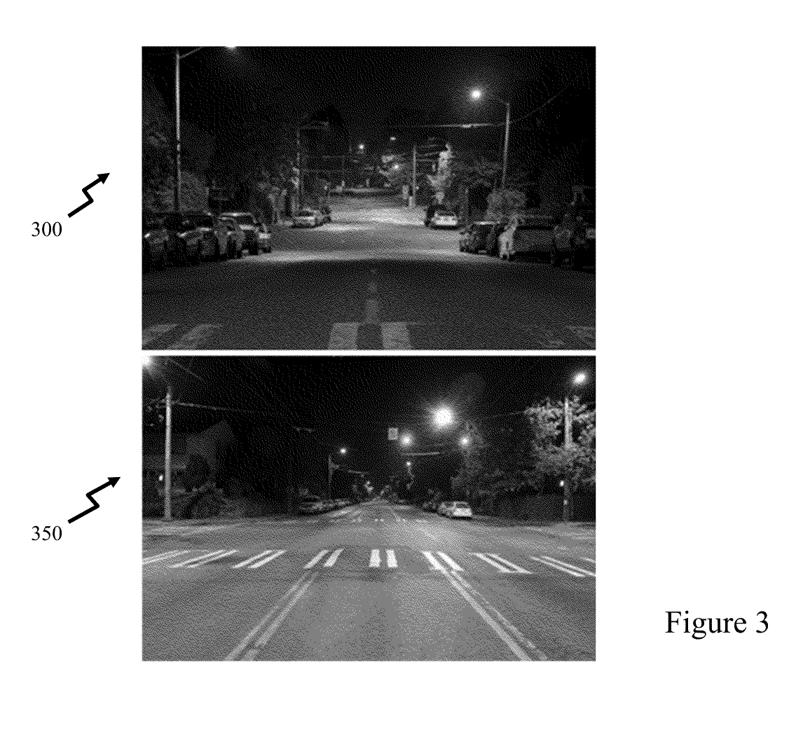

As noted supra renewal of urban infrastructure is typically considered on a service by service basis with no consideration of other services as each service is essentially independent of the other and managed by different branches of a municipality, government, region, or enterprise for example. Accordingly, replacing traffic light stands occurs without consideration of street lighting. Only where a physical infrastructure such as water mains, sewage, gas etc. involve ingress into substantial portions of an area of urban infrastructure, e.g. the entire road width through a neighborhood shopping center, may such coordination occur or be considered. Further, the timing and schedules for these different services are typically offset and of different “life-cycles.” However, in some instances technological evolution in an aspect of a service cause disruption to one or more of these life-cycles. For example solid state displays and lighting, based upon high efficient LEDs and Organic LEDs (OLEDs) have already impacted significantly many consumer electronics, e.g. laptops, televisions, digital signage, etc. and are now increasingly common in residential applications for domestic lighting as well as being employed in some vehicles and traffic lights. The advantages of such solid state lights (SSLs) in street lighting (Solid State Street Lighting—SSSL) have already resulted in hundreds of installations throughout North America and thousands globally. These advantages over High Intensity Discharge (HID) lamps such as sodium-vapour, mercury vapour, xenon, metal-halide and ceramic metal-halide include improved nighttime visibility and safety through better color rendering, more uniform lighting distributions, the elimination of dark areas between light stands, and reduced direct and reflected up-light which are the primary causes of urban sky glow. Referring to FIG. 3 there are depicted first and second images 300 and 350 of East Aloha Street in Seattle under HID sodium and SSSL illumination respectively wherein municipal environment is at slightly different locations on East Aloha Street. It is evident from second image 350 how SSSL provides improved colour rendition, more uniform light distribution, etc.

However, in addition to these benefits SSSL systems offer substantial energy savings, for example 40-80%, depending upon the incumbent lighting source and lighting design criteria, and significant maintenance savings, for example 50-90%. For example, a 100 W High Pressure Sodium (HPS) “cobra-head” light may be replaced by a 25 W LED assembly offering over 50,000 hour lifetime (approximately 12 years). These benefits typically result in a return on investment of 5-7 years to repay the costs of installing new stands, light fixtures, and the more expensive lamp assemblies. However, the inventors have established that in addition to the energy savings arising from the reduced power consumption, and the maintenance savings which can be realized when the photo-cell is also replaced, that an accelerated payback may be achieved, potentially of 2-3 years where intelligent control is deployed within the infrastructure in the municipal environment. Today, LED “cobra-style” lights are significantly more expensive than conventional HID “cobra-head” style lights. Further, today, a lack of SSSL standardization means SSL assemblies are offered with multiple wattages and issues arise from the complexities of getting new rates approved. Accordingly, most regulated Investor Owned Utilities (IOUs) today do not offer SSSL tariffs for unmetered street lights. Therefore, even if a city converts all of the street lights to LEDs and reduces the power consumption by 50% or greater, most IOUs will only reduce the street lighting bill slightly or not at all.

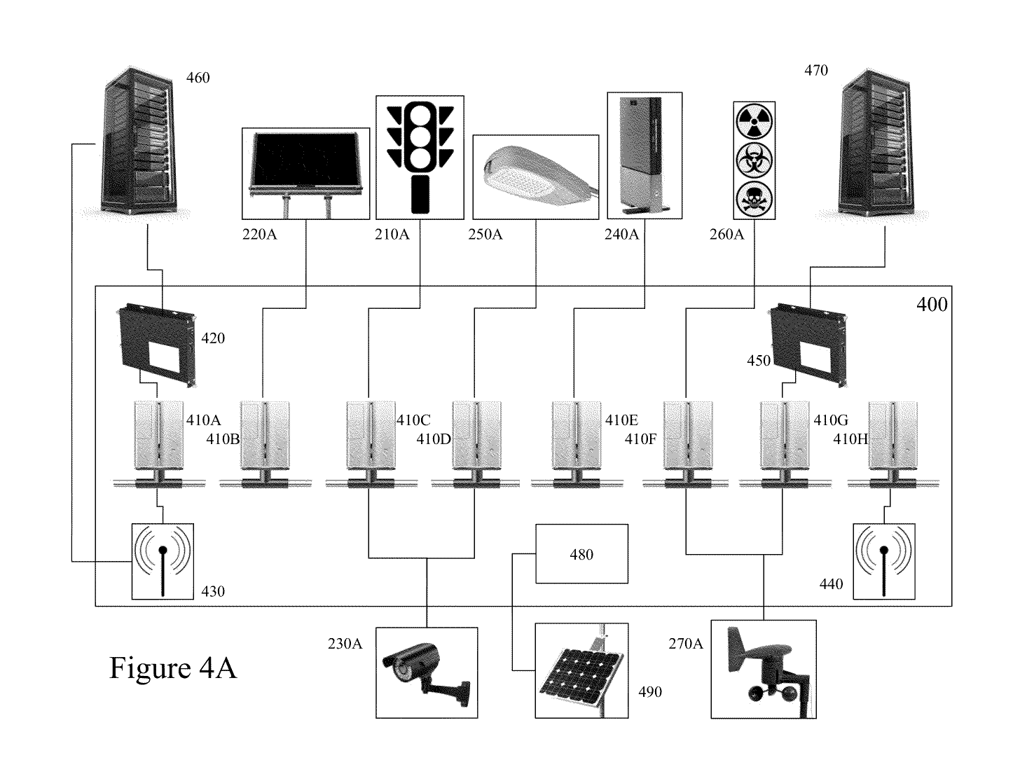

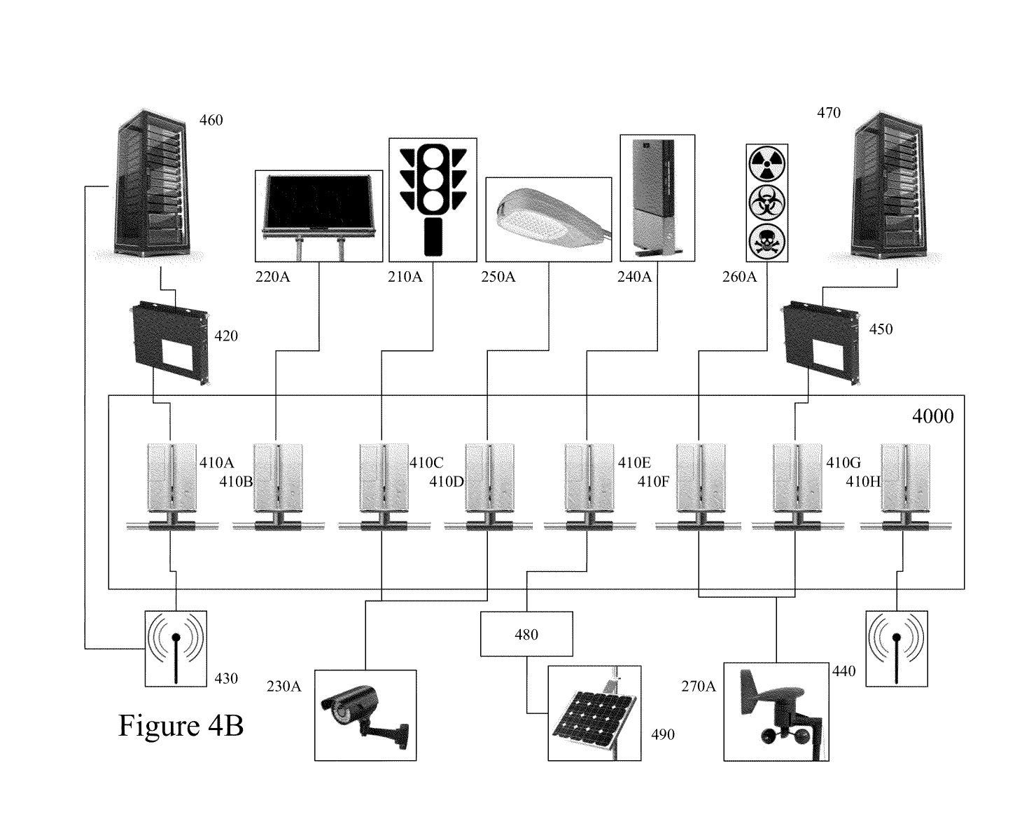

Now referring to FIG. 4A there is depicted an Infrastructure Interface Module (IIM) 400 according to an embodiment of the invention supporting multiple infrastructure elements. As depicted IIM 400 incorporates first to eighth interfaces 410A through 410H respectively. First management interface 410A is coupled to first wireless interface 430 and first wired interface 420. First wired interface 420 supports electrical/optical communications to a network, not shown for clarity, and thereafter first server 460 for data acquisition/data archiving for example. First wireless interface 430 supports wireless communications to first server 460 such as by Global System for Mobile Communications (GSM) to cellular base station and therein via a network, not shown for clarity, such as network 200. Optionally, first wireless interface 430 and first wired interface 420 communicate to different servers or may each communicate to a plurality of servers some common to both interfaces and others not. Seventh management interface 410G provides informatics management and communicates via second wired interface 450 and network, not shown for clarity, such as network 200 for example to a remote server 470 for data acquisition/data archiving to provide services including, but not limited to, geographic information services. Seventh management interface 410G may also acquire local information such as from Environmental Sensor 270A. Eighth management interface 410H communicates via second wireless interface 440 to provide a local wireless network, such as for example Wi-Fi (IEEE 802.11) or WiMAX (IEEE 802.16).

Second to sixth management interfaces 410B through 410F respectively provide informatics management, signalling management, SSL management, data services management and alarm management. These second to sixth management interfaces 410B through 410F respectively may be coupled to Sign 220A, Traffic Lights 210, CCTV Camera 230A, Light 250A, Wi-Fi cell 240A, Sensor 260A and Environmental Sensor 270A thereby providing centralized information acquisition, diagnosis, management, and communications from IIM 400 to infrastructure elements as well as through communications to remote servers and control centers, via a network, not shown for clarity, such as network 200, in addition to other services, including but not limited to, automated and/or user directed remote control and informatics. Also shown is Solar Panel 490 connected to Power Circuit 480 allowing localized electricity generation to be part of the infrastructure stand either for elements associated with that specific IIM 400 or with elements associate with other IIMs 400. Optionally, generated electricity may be stored within local and/or remote power storage means. Such local/remote storage means may provide optionally for transfer of generated power to an electrical utility, local enterprise, or municipal facility for example. Equally, other local power sources may be available, including, but not limited to, wind through micro-turbines, small turbines, and vertical axis turbines. Optionally, Power Circuit 480 may interface to other local micro-generation sources associated with other local infrastructure such as solar panels on a house, office building, factory etc. allowing excess electricity to be either locally stored and/or supplied. Within prior art architectures such pole mounted and/or local micro-generation due to the absence of localized intelligence cannot be metered and provisioning of net metering and associated aspects of dynamic power management, financial management, etc. cannot be performed.

Now referring to FIG. 4B there is depicted an Infrastructure Interface Module (IIM) 4000 according to an embodiment of the invention supporting multiple infrastructure elements. As depicted IIM 4000 similarly incorporates first to eighth interfaces 410A through 410H respectively but now Solar Panel 490 is connected to Power Circuit 480 which is eternal to IIM 4000 as are first wireless interface 430, first wired interface 420, second wireless interface 440, and second wired interface 450. Power Circuit 480 is now shown connected to fifth management interface although it may alternatively communicate directly to other circuitry within the IIM 4000 which is not depicted for clarity such as microprocessor, memory, etc. In this manner, the IIM 4000 may be disposed upon a standard wherein the other physical elements and interfaces may be mounted to the same standard and/or other standards. Similarly, multiple luminaires (e.g. lights 250A) may be mounted to the same standard and/or other standards.

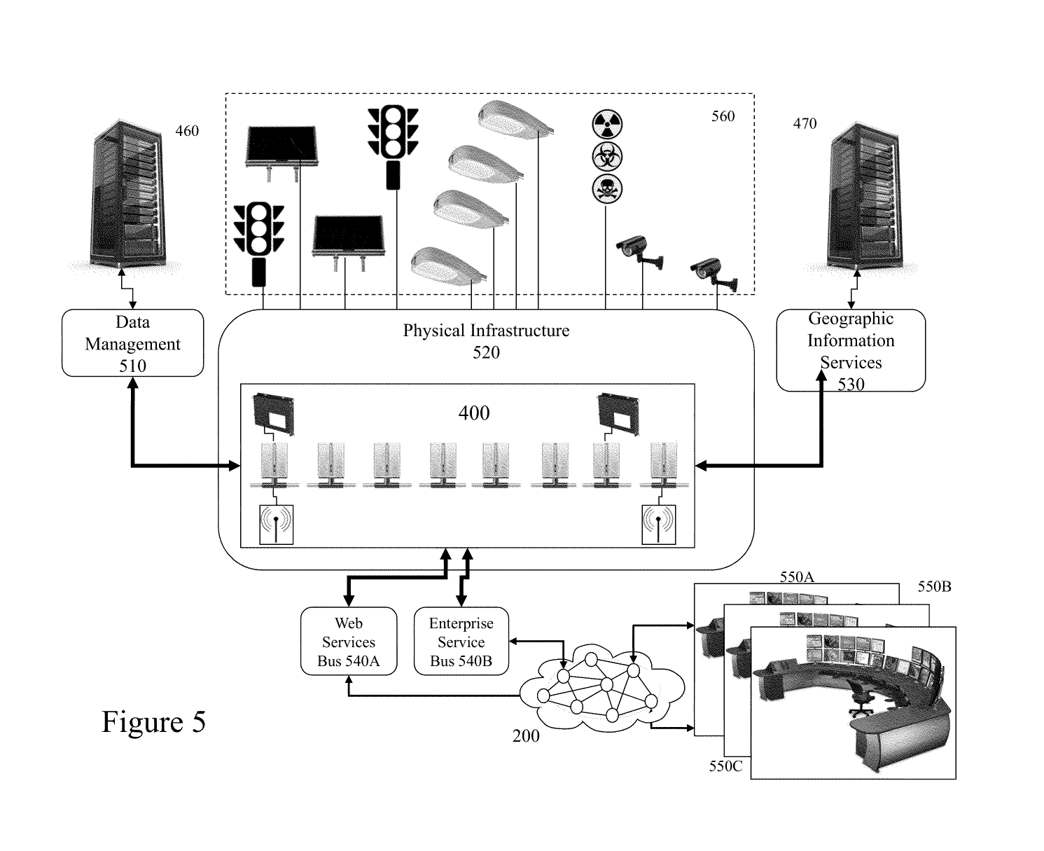

It would be evident to one skilled in the art that IIM 400/4000 allows for further adjustment in the return on investment equation for infrastructure replacement as the IIM 400/4000 now facilitates revenue generation through supporting services such as data acquisition, security monitoring, digital signage, wireless services, etc. Now referring to FIG. 5 an IIM 400/4000 is depicted as coupled to Network/Physical Infrastructure 520 as well as Data Management 510 and Geographic Information Services 530 which provide and receive data from IIM 400/4000. The IIM 400/4000 is also coupled to first to third Control Centers 550A through 550C via Web Services Bus 540A and/or Enterprise Service Bus 540B, and/or some other such interface, allowing services to be provided in a scalable and easy to adapt manner over a standardized interface. As depicted the IIM 400/4000 is part of Physical Infrastructure 520, such as a stand, for example, to which Infrastructure Elements 560 are supported. Such elements may include, but not limited to, traffic lights, digital signs (displays), “cobra-head” lights, chemical sensors, environmental sensors, acoustic sensors, a wireless antenna, radiation detectors, and CCTV camera(s).

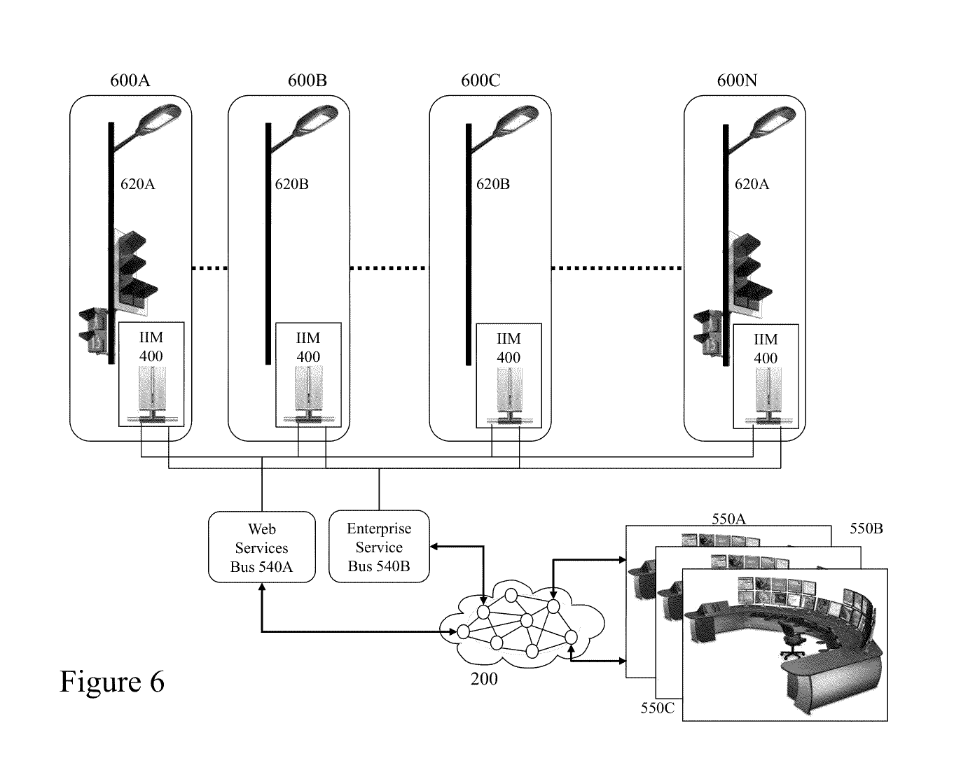

Now referring to FIG. 6 a plurality of Infrastructure Stands 600A through 600N are depicted with IIM 400/4000 within each and therein coupled to first to third Control Centers 550A through 550C via Web Services Bus 540A and/or Enterprise Service Bus 540B and/or some other such interface. As depicted some infrastructure, e.g. Infrastructure Stands 600A and 600N comprise SSSL and traffic control elements whereas others, e.g. Infrastructure Stands 600B and 600C, comprise solely SSSL elements. However, according to embodiments of the invention each IIM 400/4000 supports a variety of interfaces and infrastructure elements such as depicted in FIGS. 4 and 5 respectively such that each may automatically configure at installation, or be configured, and support the integration/assembly of additional elements subsequently without requiring additional configuration, electrical interfaces, cabling etc.

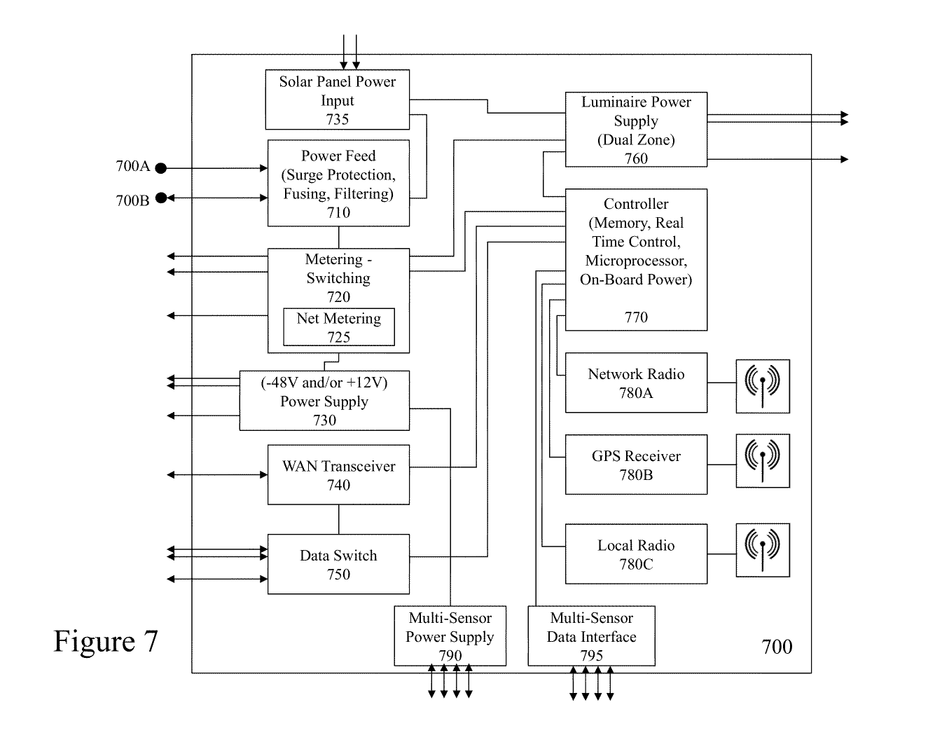

Referring to FIG. 7 there is depicted an Infrastructure Interface Module (IIM) 700 according to an embodiment of the invention such as described supra in respect of the IIM 400/4000 in FIGS. 4 and 5 respectively. As depicted IIM 700 comprises a Controller 770 which comprises, for example, microprocessor for executing real time control software relating to elements connected to it as well as those relating to managing the IIM 600 itself and communications to remote network elements, remote controllers, servers, geographic information systems, data management systems etc. for example. As such the Controller 770 within IIM 700 is coupled to GPS Receiver 780B which provides geographic location data and time data allowing automatic configuration of aspects of IIM 700, such as timing for turning SSSL and/or SSL elements on and off based upon latitude, longitude and week/day for example and automatic configuration for solar eclipse and lunar eclipse events. Optionally, Controller 770 may receive other information such as weather data, weather forecasts, and/or light sensors that may provide additional input information to controlling the SSL/SSSL. Such information may also be automatically added to data transmitted from the IIM 700 such as being geocoded into CCTV video, alarm signals, etc. Controller 770 is also coupled to Network Radio 780A, such as GSM for example, and Local Radio 780C, such as Wi-Fi (IEEE 802.11) or WiMAX (IEEE 802.16), for example, as well as those supporting other wireless communication standards including, but not limited to, Zigbee, Wireless m-Bus (EN13757-4:2005 and 2012), Bluetooth, etc. This Network Radio 780A may provide interconnection of Controller 770 and IIM 700 to a network, such as Network 200 in FIGS. 5 and 6 respectively. Controller 770 is also coupled to Multi-Sensor Data Interface 795 to receive sensor/alarm data from external sensors including, but not limited to, chemical, nuclear, explosive, natural gas, atmospheric, temperature, wind speed, acoustic, and vibration. Power to these sensors being provided via Multi-Sensor Power Supply 790 which is connected to Power Supply 730 which provides standard power rails, for example −48V and/or ±12V. Optionally, with some interface standards, such as Universal Serial Bus (USB), the data interface and power supply connections may be combined rather than separated. The −48V power supply supports interfacing to standard telecom equipment.

Power Supply 730 is interfaced to Metering-Switching 720 which in turn is connected to Controller 770 and Power Feed 710 which provides surge protection, fusing, filtering and other signal conditioning to electrical power in-feed 700A, electrical power out-feed 700B and Solar Panel Power Input 735 which receives electrical power from an external solar panel (or other localized micro-generation) if provided. Also provided within Metering-Switching 720 is Net Metering 725 which provides for metering of services associated with the IIM 700 and supported infrastructure including, but not limited to, wireless data services, generated electrical power provided to external utility, and power consumed by infrastructure elements associated with the IIM 700. Optionally Metering-Switching 720 provides metering information, e.g. a metering value or metering cost, associated with the net electrical power consumption of the IIM 700 and associated infrastructure elements. Alternatively, Metering-Switching 720 provides multiple metering values associated with, for example, power consumed versus time, power generated versus time, net consumption/generation versus time to account for variable rates of electricity with time of day, for example. Optionally, Net Metering 725 is a separate module to Metering-Switching 720 and generates net metering values and/or costs in dependence upon infrastructure element activities including for example communication activities with Network Radio 780A, communication activities with Network Radio 780C, communications via Data Switch 750, and communication activities with Fiber Optic Transceiver 740. Such communications may include identification of communications broadcast versus those employed locally to IIM 700 such as data displayed upon an associated digital signage device.

Controller 770 is depicted as also being coupled to WAN Transceiver 740 and Data Switch 750 which may provide connection for IIM 700 to the network, e.g. Network 200 in FIGS. 5 and 6 respectively, or may be connected to other networks, directly to one or more servers or directly to one or more control centers for example. WAN Transceiver 740 may be wired, wireless, optical, or a combination thereof. Controller 770 is also connected to Dual Zone Luminaire Power Supply 760 which is also connected to Metering-Switching 720 allowing Controller 770 to control two luminaires. Alternatively, the power supply for the luminaires may be configured to be single zone, triple zone, or quad zone for example. Optionally, it may be modular allowing configuration based upon deployment scenario such as for 1, 2, 3, or more zones, for example, or for the IIM 700 to operate with SSSLs that are scalable, such as the GE Evolve™ for example, or banded in power, e.g. 25-60 W and 70 W-110 W for example, or with IIM 700s that support SSSLs as well as SSLs in bollards and other fixtures for example.

Metering information associated with IIM 700, and other associated elements, allows, for example, monitoring of battery charge and discharge cycle rates, for example in embodiments of the invention with pole-mounted or associated solar panels, thereby allowing the inference of battery health conditions. This enables pro-active and timely battery maintenance as opposed to fixed duration maintenance cycles thereby offering reduced maintenance costs and improving system performance. As discussed supra Controller 770 is connected to Dual Zone Luminaire Power Supply 760 which enables different behavior to be enabled on one side of an area, e.g. street, to another side of the area, e.g. the other side of the street. For example, a path may be illuminated brightly whilst the adjacent basketball court is dimly lit or unlit, lighting may reflect a chase, provide visual effects, as well as other specialized applications. Optionally, Controller 770 may be connected to luminaire power supplies that support three or more zones as well as controllers for other LED lighting fixtures with programmable/controllable illumination patterns.

Optionally, only every IIM 700 may include a GPS receiver device or alternatively an IIM 700 may have no integral GPS receiver but rather receive GPS data from GPS receivers integrated to the light fixture. Similarly, each IIM 700 and each interfaced light fixture may have integral GPS receivers so that not only can the IIM 700 device be mapped but equally so can the light fixtures. In such situations the IIM 700 may adjust the program for each light fixture based upon the local environment to each light fixture after installation based upon a variety of factors including, but not limited to, area function as defined by municipality, mapping data retrieved from third party applications such as Google™ Maps, MapQuest™, etc., special events identified from Internet, local business associations, municipality resources, etc., and sensors associated with the IIM 700 or light fixture. It would be evident that determining a GPS location, associating it to an area of a third party application, and GUI maps for the municipality, emergency resources etc. may require that the GPS location is processed in order to remove jitter arising from errors within the GPS location system, etc. Accordingly, the IIM 700 in conjunction with the GPS location data position may exploit an algorithm such that an average position is reported and that average position is calculated over a long duration, e.g. minute, hours, etc. such that jitter is reduced/eliminated. Optionally, the averaging duration may be set to an initial low value, e.g. 1 minute, so as to not impact installation or maintenance which is then replaced with a more extended duration based upon the IIM 700 completing installation activities etc.

Optionally, other modules may be interfaced to IIM 700 such as digital signage allowing for example traffic data to be communicated to drivers at traffic lights or advertising/information to be communicated to pedestrians, etc. upon light standards. In some embodiments of the invention the advertising/information may be generated and managed by the municipality/owner of the standards upon which the signage is integrated with IIM 700 interfaces or it may be leased to a third party allowing for additional revenue generation to the municipality/owner of the standards upon which the signage is integrated. In other embodiments of the invention, the signage upon a standard within a shopping environment may provide advertising information to passers-by paid for by the local retailer(s) etc. whilst within a residential neighborhood such signs may provide, for example, a municipality with the ability to provide information such as public safety and/or traffic information. Optionally, the signage may provide the ability for a municipality to dynamically adjust road speed limits based upon conditions, environment, context, etc. For example, a municipality may establish that local speed limits in residential roads are 50 km/h except within 1 kilometer of a school wherein they are 40 km/h during the hours of 09:15-11:45, 13:15-15:30 pm when school is open and classes running etc. and 30 km/h specifically between 08:30-09:15, 11:45-13:15, and 15:30-16:15 to reflect the school start, lunch recess, and finish times wherein students are within the neighborhood on their way to/from school. Similarly, dynamic road traffic information can be provided or road restrictions applied rapidly and remotely with real time display.

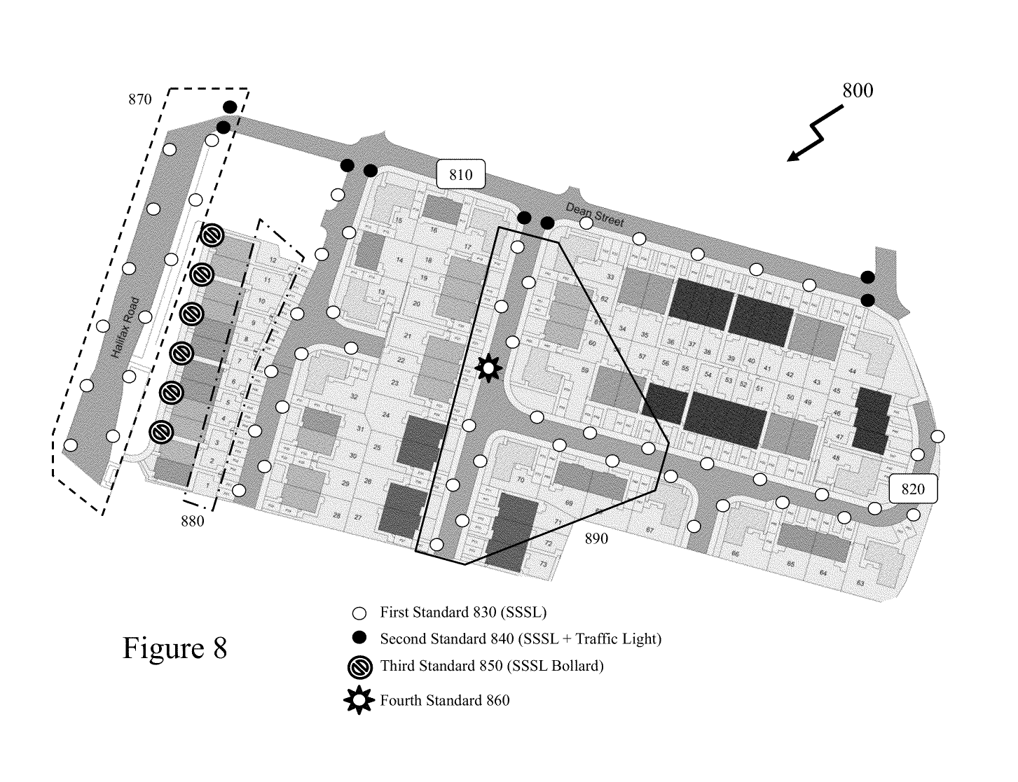

Referring to FIG. 8 there is depicted an urban environment 800 with first and second standards 830 and 840 respectively, representing standards with SSSLs and SSSLs+Traffic Lights respectively as well as other infrastructure elements as discussed supra in respect of FIGS. 4 through 7 respectively including, for example, acoustic sensors, chemical sensors, and CCTV cameras. As depicted first standards 830 are deployed along the streets within the urban environment 800 whereas second standards 840 are deployed at some junctions between streets within the urban environment 800. First and second standards 830 and 840 respectively comprise SSSLs which operate according to a schedule determined in dependence upon the GPS receiver data in conjunction with the controller within the IIMs within each of first and second standards 830 and 840 respectively, such as described supra in respect of FIG. 7 for example. The schedule takes GPS time information, GPS locations data, and geographic information to provide ON/OFF timing information but also the first and second standards 830 and 840 respectively have a third setting of reduced intensity which relates to a period of time within the ON setting where reduced power is sufficient. For example an IIM may determine that the standard(s) to which it relates is within a residential neighborhood, derived from GPS location data and remotely accessed geographic information, such that for example in Ottawa, Ontario on May 1, 2013 the ON period is between 30 minutes before sunset (8:10 pm May 1) and 30 minutes after sunrise (5:49 am May 2).

However, based upon the geographic information establishing it as a residential neighborhood then a second ON period is also defined between 00:30 am and 05:00 am wherein the luminaires are established at a lower setting due to reduced activity typically between these times. However, those standards on Halifax Road, First Zone 870, are identified as highway such that this second reduced illumination period is not triggered. Along the edge of Halifax Road fourth standards 860 are bollards along the edge of a driveway behind residences 880 which based upon this geographic information have an ON period coinciding with that of first and second standards 830 and 840 respectively but now are OFF during the third period unless based upon acoustic sensor triggering they are turned ON. Similarly, detection of an acoustic event at fourth standard 840, e.g. a gunshot, results in all standards within Second Zone 890 turning ON and CCTV cameras within the vicinity streaming both to remote control centers, not shown for clarity, but also to Emergency Response Vehicle 810. In this manner personnel within Emergency Response Vehicle 810 may gauge their approach into Second Zone 890 as well as determining early whether additional emergency personnel and different emergency services are required.

Optionally, an Infrastructure Interface Module such as IIM 700 may include a topographical mapping overlay feature such that the IIM will know if the lighting fixtures are for example on the east side or west side of a hill, mountain, or skyscraper for example. Accordingly, the IIM may determine whether they will be shadowed during sunrise, sunset, or other times for example therefore modifying further the turn-on/turn-off times for these particular features. Further, the IIM may extract local weather information from a meteorological service, weather radar, etc. and determine whether turn-on/turn-off times may require modification or whether additional periods of lighted operation should be provided.

Optionally, luminaires within Second Zone 890 may be set into strobe or flashing mode by Emergency Response Vehicle 810, remote control center, or automatically to indicate warning to individuals within and/or outside Second Zone 890. Optionally, acoustic sensors within standards in the vicinity of fourth standard 860 may be enabled to provide information to the personnel within Emergency Response Vehicle 810 as well as optionally other responders, remote control center, etc. It would be evident to one skilled in the art that triggers for alarms, emergency response personnel, etc. may be established based upon the elements deployed in standards with IIMs according to embodiments of the invention. Such triggers may be acoustic, such as a scream, car crash, voice recognition of keyword(s) etc.; chemical, e.g. petroleum vapour, explosive, smoke, etc.; vibration, e.g. earthquake; as well as for example those associated with other aspect of the IIM including for example determination of a power cut/power failure. In other embodiments of the invention other sensors such as infrared sensors, infrared CCTV, thermal imaging cameras, camera etc. may be associated with a standard and therein an IIM. Such sensors being typically are referred as optical sensors. In such instances, wherein primary network access such as via wireless and/or wired networks may be disrupted then the IIM(s) may provide capabilities for establishing ad-hoc wireless networks for emergency services etc. or for all local users. In the former instance the IIM(s) may support ad-hoc networking through GSM interfaces allowing larger range ad-hoc network configurations and wherein the IIM(s) only allow association from PEDs associated with the emergency services through authorised device identities, for example.

As indicated in FIG. 7 Power Feed 710 is connected to external power cabling to either receive power from a remote source via Power In-Feed 700A or provide power to a remote sink (load) via Power Out-Feed 700B. Optionally, Power In-Feed 700A and Power Out-Feed 700B may be via an electrical storage means, e.g. re-chargeable batteries installed within the standard within which the IIM is installed such that in the event of a local or wider power cut one or more infrastructure elements supported by the IIM may be maintained, e.g. SSSL via Luminaire Power Supply 760, Network Radio 780A and Local Radio 780C. Where the IIM is interfaced to a solar panel through an integral element of the IIM or as a separate module the Power Out-Feed 700B may be used solely in some instances to power the IIM and associated infra-structure whilst in others it may be used to power the IIM and associated infra-structure and keep an associated battery charged, and in others to power the IIM and associated infra-structure, keep an associated battery charged, and provide surplus power to a remote utility and/or other IIMs etc.

Optionally, the IIM may include a wireless base station in addition to, or as a replacement for, Network Radio 780A operating according to a predetermined telecommunications standard such as WiMAX (IEEE 802.16), LTE (Long Term Evolution, 3rd Generation Partnership Project Release 8/9), and GSM (Global System for Mobile Communications) for example.

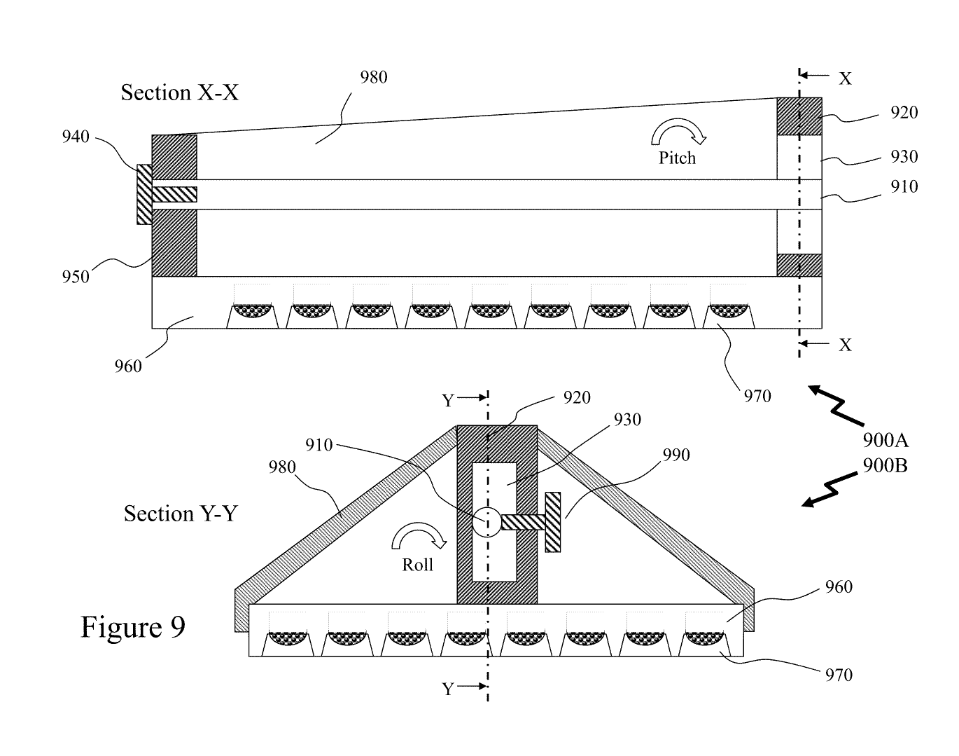

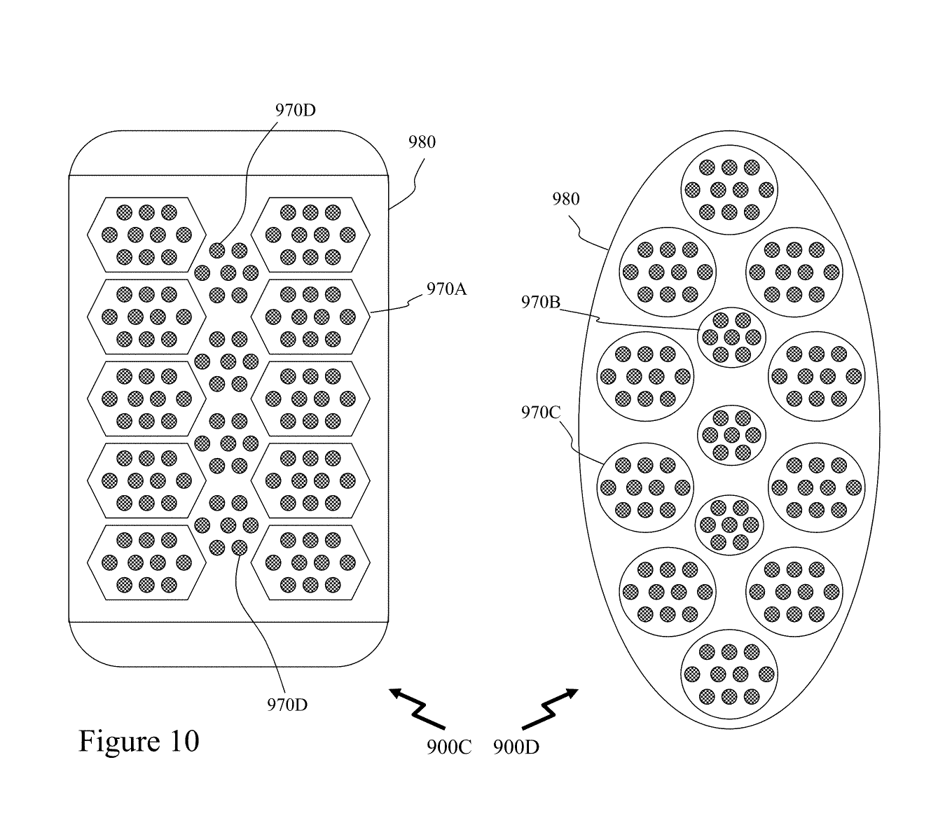

As described supra in respect of FIGS. 4 through 8 light fixtures are described as being interfaced to Infrastructure Interface Modules (IIMs), such as IIM 700 in FIG. 7. As described an IIM may now include all power and control electronics reducing the light fixture to a passive element requiring simply a physical mounting and an electrical connection to the IIM. Referring to FIGS. 9 and 10 there are depicted first and second cross-sectional views 900A and 900B of a light fixture according to an embodiment of the invention, together with first and second bottom perspective views 900C and 900D indicating examples of overall geometry and solid state emitter distributions within the light fixture according to an embodiment of the invention.

As depicted the light fixture comprises a Shell 980 with first and second Mounting Plates 920 and 950 disposed at either end. Second Mounting Plate 950 fits atop one end of Support 910 and is attached via first Screw 940. First Mounting Plate 920 is attached to Support 910 via second Screw 990 but as first Mounting Plate 920 also comprises Slot 930 the Shell 980 may be adjusted for angular offset in respect of pitch and due to the circular cross-section of Support 910 it may also be adjusted for angular offset in respect of roll. Fitted to the lower portion of Shell 980 is LED Array 960 with an array of LEDs 970. As would be evident the Shell 980 may be lightweight as no power electronics are required within it and accordingly the physical requirements for the Support 910 and the light stand to which it attaches, not shown for clarity, may also be reduced substantially even where multiple light fixtures are attached.

As depicted in first and second bottom perspective views 900C and 900D the Shell 980 may be rectangular, elliptical, circular, polygonal, etc. and comprise arrays of LEDs 970, such as first, second, and third LED arrays 970A to 970C respectively as well discrete LEDs 970D. Optionally, the Shell 980 may include heat dissipative elements according to the power dissipation of the light fixture, environmental parameters, etc.

Within the embodiments of the description supra, network interfaces have been described as being provided by one or more transceivers, whether wired, wireless, optical, or a combination thereof. However, within other embodiments of the invention some IIMs may be implemented solely with a transmitter or transmitters whilst others may be implemented solely with a receiver, with receivers, with a transceiver, with transceivers and a combination thereof. Accordingly, some architectures and deployment scenarios wherein multiple deployed IIMs communicate to an IIM hub.

Specific details are given in the above description are intended to provide an understanding of those embodiments of the invention. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), system on a chip (SOC), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit or SOC (System on a Chip). The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device comprising:
a microprocessor;
at least one wireless device operating according to a predetermined standard, the wireless device being at least one of a receiver, transmitter, and a transceiver;
at least one luminaire power supply; and
at least one power feed input.

2. The device according to claim 1, further comprising;
a metering-switching circuit coupled to the microprocessor, the luminaire power supply, and power feed input for determining a metered value;
at least one transceiver operating according to a predetermined standard for transmitting the metered value to a remote server.

3. The device according to claim 2, wherein the at least one transceiver operating according to a predetermined standard is at least one of a wide area network (WAN) transceiver and a data switch.

4. The device according to claim 1, further comprising a global positioning receiver for determining a geographical location of the device, wherein the geographical location is employed by the microprocessor to establish, independent of other input the schedule for turning the luminaire power supply output at least one of on and off.

5. The device according to claim 1, further comprising a timing receiver for providing precise timing information, the timing receiver comprising at least one of a global positioning receiver and a receiver according to a second predetermined standard.

6. The device according to claim 1, further comprising a DC power supply for generating a standard output voltage according to a predetermined telecommunications equipment standard.

7. The device according to claim 2, further comprising a second wireless transceiver operating according to another predetermined standard and a net metering circuit for determining a net metering value in dependence upon the activities of at least one of the first wireless transceiver, the second wireless transceiver, and the at least one transceiver.

8. The device according to claim 1, wherein the device is discrete from but controls at least one of a luminaire and a luminaire head.

9. The device according to claim 1, wherein the device controls at least two lighting devices, each lighting device being at least one of a luminaire and a luminaire head.

10. A method comprising:
deploying a plurality of infrastructure interface modules (IIM), each IIM associated with a luminaire standard deploying a plurality of luminaires and comprising:
a microprocessor;
at least one luminaire power supply;
at least one wireless device operating according to a predetermined standard, the wireless device being at least one of a receiver, transmitter, and a transceiver; and
at least one power feed.

11. The method according to claim 10, wherein
a predetermined subset of the IIMs each control two or more luminaires of the plurality of luminaires.

12. The method according to claim 10, wherein
each IIM further comprises:
a global positioning receiver for determining a geographical location of the device, wherein the geographical location is employed by the microprocessor to establish independent of other input the schedule for turning the luminaire power supply at least one of on and off; and
a sensor interface coupled to at least one sensor of a plurality of sensors, each sensor providing a sensor output in dependence upon a predetermined factor; and
each IIM determines in dependence upon a decision made by the microprocessor in dependence upon the at least one sensor output whether to at least one of generate and send an alarm signal from the IIM and override the luminaire power schedule and turn on the luminaire power supply.

13. The method according to claim 10, wherein each IIM further comprises:
a metering-switching circuit coupled to the microprocessor, the luminaire power supply, and power feed input for determining a metered value;
at least one transceiver operating according to a predetermined standard for transmitting the metered value to a remote server.

14. The method according to claim 10, wherein each IIM further comprises a global positioning receiver for providing at least one of a geographical location of the IIM and accurate timing information to the IIM

15. The method according to claim 10, further comprising a DC power supply for generating a standard output voltage according to a predetermined telecommunications equipment standard.

16. The method according to claim 13, further comprising a second wireless transceiver operating according to another predetermined standard and a net metering circuit for determining a net metering value in dependence upon the activities of at least one of the first wireless transceiver, the second wireless transceiver, and the at least one transceiver.

17. The method according to claim 12, wherein the factor is at least one of an environmental characteristic, a chemical, a predetermined acoustic event, and a fluid.

18. The method according to claim 10, wherein generating and sending an alarm signal comprises at least one of sending the alarm signal via the wireless transceiver and controlling the luminaire power supply to generate a visible alarm signal with a luminaire connected to the luminaire power supply.

19. A device comprising:
an outer shell;
a first mounting for attaching a first end of the outer shell to a support, the support for attaching the device to a physical structure; and
a second mounting for attaching a second end of the outer shell to the support; wherein
the first mounting and second mounting allow for the outer shell to be adjusted in both pitch and yaw relative to the support.

20. The device according to claim 19, wherein the outer shell comprises an upper protective cover and a plurality of solid state optical emitters.

21. The device according to claim 19, wherein the outer shell comprises a plurality of solid state optical emitters and electrical connections for supplying power from a remote power source to the plurality of solid state optical emitters.
